(19) United States
(12) Patent Application Publication
(10) Pub. No.: US 2007/0103329 A1
(43) Pub. Date: May 10, 2007

(54) Direction indicating device

(76) Inventor: Ming Hung Lin, Sinjhuang City (TW)

Correspondence Address: TROXELL LAW OFFICE PLLC, SUITE 1404, 5205 LEESBURG PIKE, FALLS CHURCH, VA, 22041, US

(21) Appl. No.: 11/269,723

(22) Filed: Nov. 9, 2005

(51) Int. Cl. G08B 3/00; G08B 5/36; G08B 29/00

(52) U.S. Cl. 340/691.1; 340/815.55; 340/506

(57) ABSTRACT

A direction indicating device for safe fleeing comprising a housing, a light transmitting panel connecting with the housing, two light sources including a first and a second light source in the housing and being provided respectively for two arrow symbols, a switching control unit provided in the housing for doing switching of the light sources, hence the first light source being extinguished while the second light source being lightened, thereby the two arrow symbols can be alternatively changed, in order that the people in site of an emergency can recognize a correct direction of safe fleeing.

### BACKGROUND OF THE INVENTION

1. Field of the Invention

The present invention relates to a direction indicating device for safe fleeing, and more particularly to a direction indicating device for safe fleeing having two arrow symbols with mutually opposite direction for switching direction of fleeing.

2. Description of the Prior Art

Following advancing of the times, safety of fire control in buildings gets more and more important, particularly in public places such as, hospitals, movie theaters, malls, and parking lots etc. Therefore direction indicating devices for safe fleeing now are necessities in these public places for people to follow and flee during disasters.

FIG. 1 is a perspective view of a conventional direction indicating device 1 for safe fleeing. The direction indicating device 1 generally comprises a housing 10, a light transmitting panel 12 having thereon a symbol of arrow 11 and a light source 13. The light transmitting panel 12 is fixed on the housing 10. When the light source 13 emits light and projects on the light transmitting panel 12, a direction of safe fleeing can be displayed by the symbol of arrow 11.

At present, direction indicating devices for safe fleeing seen in public places have been the same as the one stated above; such conventional direction indicating device for safe fleeing has the following defects:
1. Direction of the arrow can not be changed by the fact that the arrow on each direction indicating device for safe fleeing has shown only one indicating direction. In case of a fire alarm, if the indicating direction is exactly directing to a fire source, people suffering in the fire may have larger danger.
2. Each direction indicating device for safe fleeing is an independent allocated device, it is unable to be used integratedly with other indicating devices. So that if in a large fire, it is unable to plan for giving best safe fleeing routes for the people suffering in the fire.

In view of the above defects, the inventor of the present invention provides a direction indicating device for safe fleeing based on his professional yeas experience and nonstop studying and improvement. By the present invention the light source of the device can be changed to change the directions of arrow symbols.

### SUMMARY OF THE INVENTION

The primary objective of the present invention is to provide a direction indicating device for safe fleeing; in which the light source of the device can be changed to change the directions of arrow symbols, so that when in disasters, they can show the people in suffering the correct directions of safe fleeing.

The secondary objective of the present invention is to provide a direction indicating device for safe fleeing, a plurality of such direction indicating devices can be integrated to plan for giving best safe fleeing routes in a disaster.

To achieve the above objectives of the present invention, the direction indicating device for safe fleeing provided by the present invention comprises a housing, a light transmitting panel, two light sources including a first and a second light source, a switching control unit and a signal sensitive transceiver. The light transmitting panel is connected with the housing in order to receive the light sources, the switching control unit and the signal sensitive transceiver in the housing. The light transmitting panel is provided with two arrow symbols with mutually opposite direction and the two light sources respectively lighten the two arrow symbols. The first light source is in an illuminous state and when the signal sensitive transceiver senses a signal of a fire or leakage of toxic gas, the signal is transmitted to the switching control unit to switch light source, hence the first light source is extinguished while the second light source is lightened.

The present invention will be apparent in its structural content and the effect to be achieved after reading the detailed description of the preferred embodiment thereof in reference to the accompanying drawings.

### BRIEF DESCRIPTION OF THE DRAWINGS

FIG. 1 is a perspective view showing a conventional direction indicating device for safe fleeing;

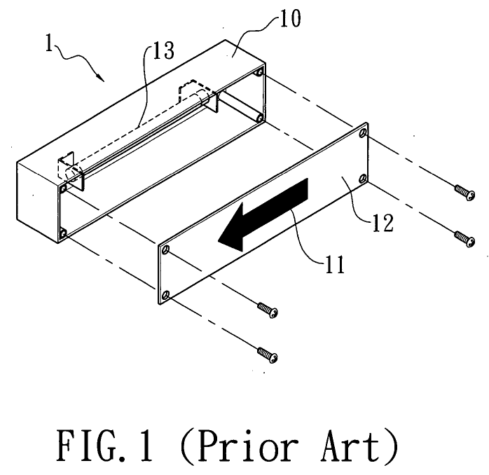

FIG. 2A is an exploded perspective view showing an embodiment of the present invention;

FIG. 2B is a perspective view after the elements in FIG. 2A are assembled with one another;

FIG. 2C is a schematic perspective view showing the embodiment of the present invention has its light source switched;

FIG. 3A is a schematic perspective view showing element allocation of another embodiment of the present invention;

FIG. 3B is perspective view after the elements in FIG. 3A are assembled with one another;

FIG. 3C is a schematic perspective view showing the embodiment of FIG. 3A of the present invention has its light sources of a plurality of direction indicating devices switched.

### DETAILED DESCRIPTION OF THE PREFERRED EMBODIMENT

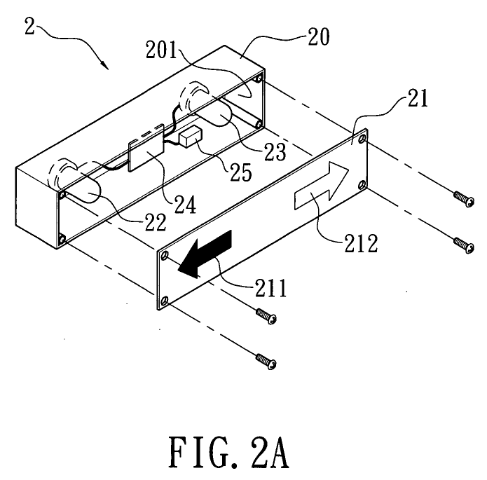

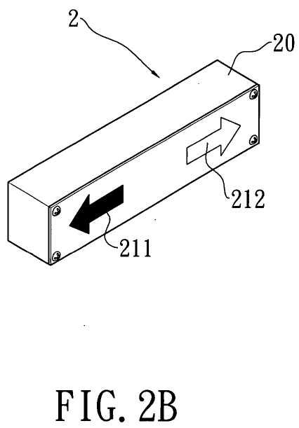

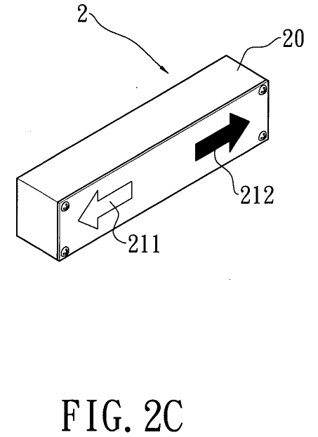

Referring to FIGS. 2A and 2B showing an exploded perspective view before assembling and a perspective view after assembling the elements respectively of a direction indicating device 2 for safe fleeing of the present invention, the direction indicating device 2 is installed in a building in order that people in an emergence can follow the safe fleeing direction. The direction indicating device 2 mainly comprises a housing 20, a light transmitting panel 21, two light sources including a first light source 22 and a second light source 23, a switching control unit 24 and a signal sensitive transceiver 25.

The housing 20 has a receiving space 201 to receive the two light sources 22, 23, the switching control unit 24 and the signal sensitive transceiver 25. The housing 20 is made of material with a predetermined heat durability. And the housing 20 is connected with the light transmitting panel 21 in order to seal the light sources 22, 23, the switching control unit 24 and the signal sensitive transceiver 25 in the housing 20.

The light transmitting panel 21 is provided thereon with two arrow symbols with mutually opposite direction including a first arrow symbol 211 and a second arrow symbol 212. The first light source 22 and the second light source 23 can project light beams onto the first arrow symbol 211 and the second arrow symbol 212.

The switching control unit 24 is communicated through electric signals with the first light source 22, the second light source 23 and the signal sensitive transceiver 25. The signal sensitive transceiver 25 can be used to receive a temperature signal and to transmit the temperature signal to the switching control unit 24. When the switching control unit 24 receives the signal from the signal sensitive transceiver 25, the switching control unit 24 can do switching of the light sources.

For instance, under the normal state, one of the first light source 22 and the second light source 23 (e.g. the first light source 22) normally is in an illuminous state. The light beams of the first light source 22 are projected on the first arrow symbol 211, so that people in an emergence can follow the fleeing direction indicated by the first arrow symbol 211. And when the switching control unit 24 receives the abovementioned signal, it does switching of the light sources. This can render the first light source 22 extinguished while the second light source 23 lightened, therefore, the second light source 23 projects light beams on the second arrow symbol 212, such as is shown in FIG. 2C. And thereby, by switching illumination of the light sources to change the arrow direction, when in a disaster, the people suffering in the disaster can recognize a correct direction of fleeing by the indication of an arrow symbol.

In a preferred embodiment, the signal sensitive transceiver 25 can be one of a temperature sensor, a smoke sensor, a light beam sensor or a toxic gas sensor. The toxic gas sensor can sense the concentration of carbon dioxide or carbon monoxide or other toxic gases. Certainly, the above stated sensors can also get electric signal communication with the switching control unit 24 through a conductor by being provided with outside of the housing 20.

And more, the switching control unit 24 can also have electric signal communication with an exterior signal receiving switchboard (not shown) to emit a signal to the switchboard and receive a signal from the switchboard. Therefore, when in an emergency (such as fire, toxic gas leakage etc.), the sensed signals provided by various sensors as stated above can be transmitted to the signal receiving switchboard, and people at a remote terminal can immediately be aware of the place where the emergency happens. An operator at the signal receiving switchboard can transmit the necessary signal to the switching control unit 24 by means of the signal receiving switchboard for changing the light sources. This will render the people in an emergency to keep far away from the site of the emergency and can successfully flee.

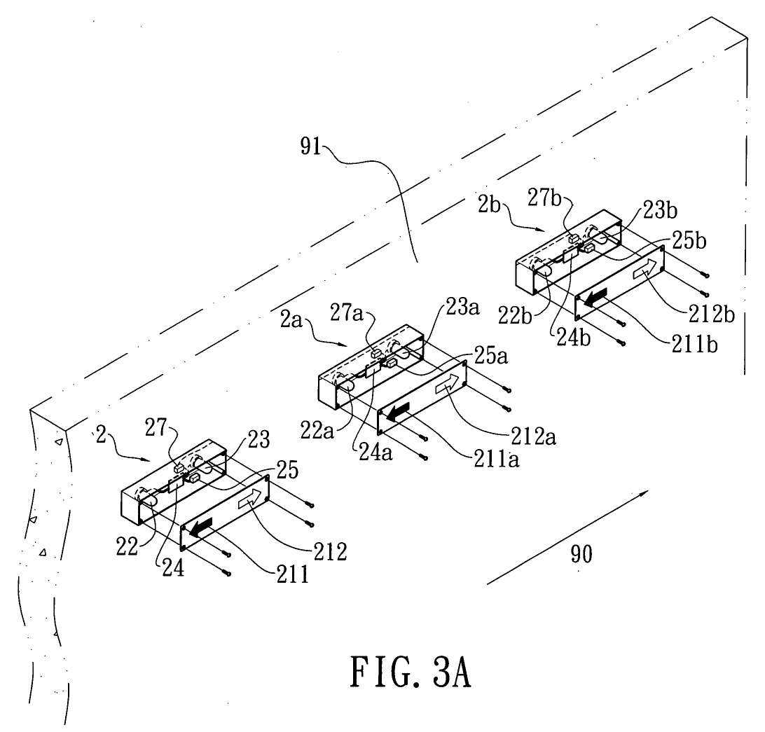

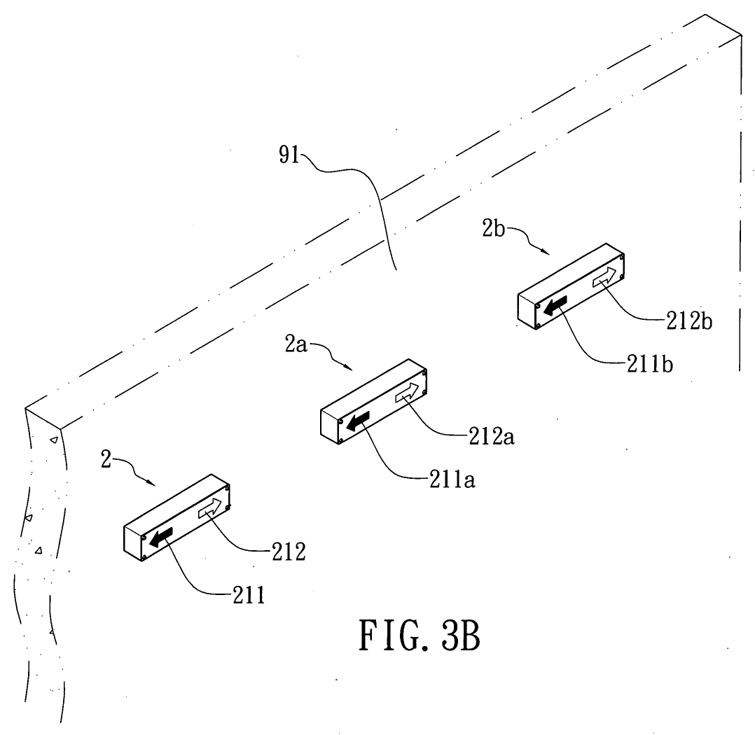

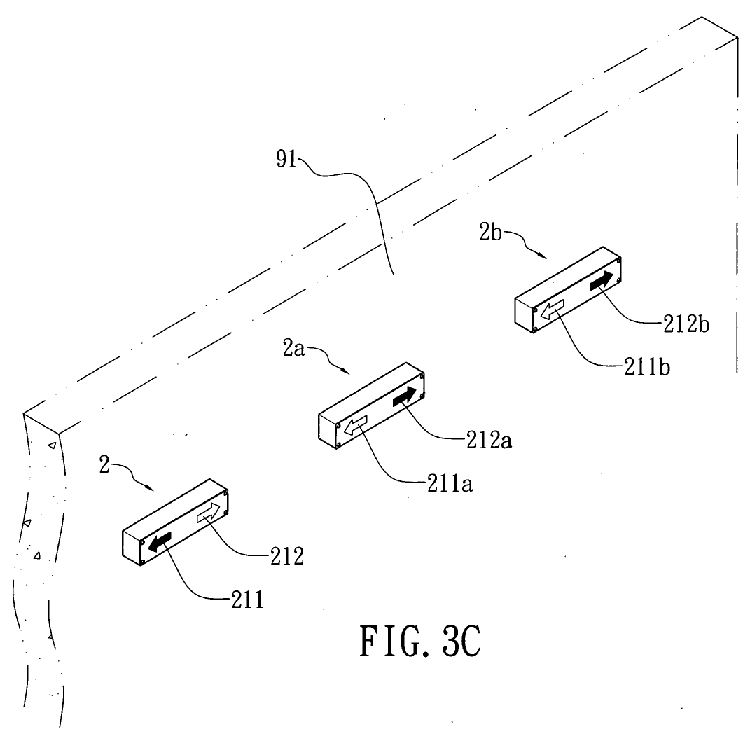

Referring to FIGS. 3A and 3B, in another preferred embodiment, a plurality of direction indicating devices for safe fleeing are provided and comprise a first direction indicating device 2, a second direction indicating device 2a and a third direction indicating device 2b spaced away a distance, and are mounted on a wall 91 following a direction 90.

Wherein switching control units 24, 24a and 24b for the direction indicating devices 2, 2a and 2b are provided respectively with emitters 27, 27a and 27b; the emitters 27, 27a and 27b are mutually communicated through electric signals, alternatively, they can do signal transmission in a wireless mode. The emitters 27, 27a and 27b can accept control signal from any of its antecedent and subsequent direction indicating devices 2, 2a or 2b, and can emit the control signal to the one of its antecedent and subsequent direction indicating devices 2, 2a or 2b to do switching of the light sources.

For example, before happening of an emergency, first light source 22, 22a and 22b of the direction indicating devices 2, 2a and 2b are in illuminous states; when in a fire, a signal sensitive transceiver 25a of the second direction indicating device 2a for instance among the direction indicating devices 2, 2a and 2b senses a temperature signal. If the value of the temperature signal is higher than a critical value, the temperature signal will be transmitted to the switching control unit 24a, and the switching control unit 24a does switching of the light sources, thus a first light source 22b is extinguished while a second light source 23a is lightened. At the same time, the switching control unit 24a transmits the signal of switching the light source to the emitter 27a. Then the emitter 27a transmits the signal to another emitter 27b, together with the light source switching of the switching control unit 24b of the third direction indicating device 2b, the first light source 22b is extinguished while a second light source 23b is lightened. An illuminous second light source 23a and the second light source 23b project light beams on corresponding second arrow symbol 212a, 212b, while the first direction indicating device 2 is left to keep the a first light source 22 illuminous, and the light beams are projected on the first arrow symbol 211 as is shown in FIG. 3C. The present invention is described here with an embodiment having three direction indicating devices: If more direction indicating devices are mounted in a space, for instance, a fourth direction indicating device is added (not shown) to be at one side of the third direction indicating device, the switching signal of the light source of the second light source will too be transmitted to the fourth direction indicating device to make it do the action that the first light source is extinguished while the second light source is lightened. That is to say, any other direction indicating device directed to by a second arrow symbol of the second direction indicating device will do light source changing too. Therefore, by integration of a plurality of direction indicating devices in cooperation with fleeing exits, it is able to plan for giving best safe fleeing routes for the people in a emergency.

The present invention thereby has the following advantages:
1. The direction indicating device for safe fleeing of the present invention can make light source switching according to a signal received, thereby the people in site of an emergency can recognize a correct direction of safe fleeing to reduce the amount of the wounded and dead.
2. Each direction indicating device can receive the signal from another direction indicating device to do light source changing. Hence a plurality of direction indicating devices for safe fleeing can be integrated to plan in cooperation with existing fleeing exits to give best safe fleeing routes for the people in an emergency.

In conclusion, according to the description disclosed above, the present invention surely can get the expected objectives thereof to provide a direction indicating device for safe fleeing; the device undoubtedly has its practicable value, what I claim as new and desire to be secured by Letters Patent of the United States is:

1. A direction indicating device for safe fleeing comprising:
a light transmitting panel provided with two arrow symbols with opposite direction;
a signal sensitive transceiver to sense a signal;
two light sources respectively for said two arrow symbols and connecting with said signal sensitive transceiver, one of said light sources being set to be illuminous in advance;
a switching control unit communicated through electric signal with said light sources to receive a signal from said signal sensitive transceiver, and to control and change illumination of said light sources to render said light source set to be illuminous in advance and extinguished while the other one of said light sources lightened.

2. The direction indicating device for safe fleeing as in claim 1, wherein, said signal sensitive transceiver is electrically connected to a signal receiving switchboard to emit a signal to said switchboard and receive a signal from said switchboard.

3. The direction indicating device for safe fleeing as in claim 1, wherein, said switching control unit further has a transceiver, in order that when in practical using a plurality of said direction indicating devices, a control signal is emitted by a first one of said switching control units to another one of said direction indicating devices, and said first switching control unit receives a control signal from a further one of said direction indicating devices.

4. The direction indicating device for safe fleeing as in claim 1, wherein, said signal sensitive transceiver is one selected from a temperature sensor, a smoke sensor, a light beam sensor or a toxic gas sensor.

5. The direction indicating device for safe fleeing as in claim 4, wherein, said toxic gas sensor is used to sense concentration of carbon dioxide.

6. The direction indicating device for safe fleeing as in claim 4, wherein, said toxic gas sensor is used to sense concentration of carbon monoxide.

7. The direction indicating device for safe fleeing as in claim 1, wherein, said device further comprises a housing, said light transmitting panel is provided on one side of said housing, while said signal sensitive transceiver, said two light sources and said switching control unit are provided in said housing.
